(19) United States
(12) Patent Application Publication
(10) Pub. No.: US 2009/0204936 A1
(43) Pub. Date: Aug. 13, 2009

(54) Method of Performing Proximity Correction

(76) Inventors: Werner Jacobs, Muenchen (DE); Alfred Kersch, Putzbrunn (DE); Christof Bodendorf, Muenchen (DE)

Correspondence Address: SLATER & MATSIL, L.L.P., 17950 PRESTON ROAD, SUITE 1000, DALLAS, TX, 75252, US

(21) Appl. No.: 12/029,280

(22) Filed: Feb. 11, 2008

(51) Int. Cl. G06F 17/50

(52) U.S. Cl. 716/20

(57) ABSTRACT

A method of performing proximity correction of a mask layout is used during the generation of a masking structure for performing a processing step. The masking structure includes at least one opening that is delimited by a sidewall and that exposes an area that is to be processed. The method includes the steps of a) determining a value representing a flux of particles to a target portion, wherein the target portion is at least one of the group of a portion of the sidewall and a portion of the uncovered area and wherein the particles are generated during the processing of the area; and b) determining a corrected mask layout dependent on the value determined in step a).

### BRIEF DESCRIPTION OF THE DRAWINGS

In the accompanying drawings:

FIG. 1 relates to a method according to an embodiment of the invention;

FIG. 2 relates to a method according to another embodiment of the invention;

FIG. 3 illustrates the relationship between a correction value and the width of a mask opening; and

FIG. 4 illustrates the relationship between a correction factor and a value representing a particle flux.

### DETAILED DESCRIPTION OF ILLUSTRATIVE EMBODIMENTS

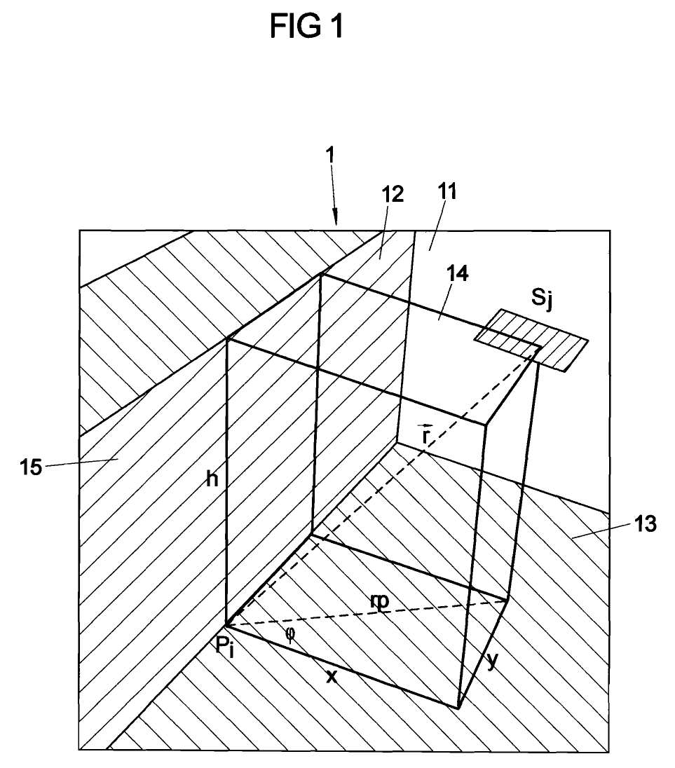

FIG. 1 depicts a masking structure 1 used during a processing step, the masking structure 1 comprising an opening 11 that is laterally delimited by a sidewall 12 and that exposes an area 13 that is to be processed by the processing step, i.e., area 13 is accessible via opening 1 1. Area 13 can be a part of a substrate, e.g., a semiconductor substrate. The masking structure 1 (e.g., a structured resist mask or a structured hard mask) was generated using a mask layout, e.g., a mask layout created by e-beam lithography. In an example, the mask layout defines an integrated circuit, wherein the masking structure is used during the fabrication of the integrated circuit.

The processing step is, for example, an etching step (in particular a dry etching process) or a deposition step (e.g., a CVD or a PVD process). In an example, the masking structure 1 is a resist structure created by an optical lithography step. The resist structure can be on top of other layers that are to be structured by an etching step. If the mask layout is used during the generation of a hard mask, i.e., the masking structure is a hard mask structure, a resist mask can be structured first using the mask layout, the resist mask in turn being used to generate the hard mask, e.g., using an etching step.

In order to generate the mask structure (i.e., opening 11 in the case of FIG. 1) that has the desired dimensions the original mask layout has to be corrected. It is known to provide a correction to the mask layout based on optical effects occurring during the generation (e.g., exposure and development) of the masking structure (optical proximity correction). However, effects occurring during the processing step have to be taken into account also. For example, a processing step in the form of an etching step has an influence on the dimensions of the structure that is to be created by the etching step (the so-called “etch bias”) such that a structure etched using mask opening 11 has dimensions (e.g., a width) that differ from the dimensions of the mask opening 11. Therefore, the mask layout has to take into account the influence of the etching step on the dimensions of the resulting structure (etch proximity correction). The same is valid in the case of a deposition step.

The invention provides a method for performing proximity correction such as etch proximity correction. According to an embodiment of the invention, a value representing a flux of particles that are created during the processing step to a target portion of the masking structure 1 is determined. The particles are, e.g., passivating radicals, e.g., oxygen radicals, if the processing step is an etching step and, e.g., ions or atoms of a conductive material if the process step is a deposition step. The target portion can be a part (or a point) of the sidewall 12 of the opening 11 of the masking structure 1 or of the area that is to be processed. Having determined the value representing the flux to the target portion, a corrected mask layout is determined depending on this value. For example, the etch bias correction is determined from the value if the processing step is an etching step.

According to the example illustrated in FIG. 1, the target portion is a point Pᵢ of the sidewall 12 and is located in the plane of area 13, i.e., the point Pᵢ is located at the base of sidewall 12. Further, it is assumed that the particles arriving at point Pᵢ emerge from a part of a cross section of opening 11 that is visible from point Pᵢ. In this example, it is contemplated that the particles emerge from a cross section 14 which is parallel to area 13 and which is located in the region of an upper side 15 of opening 11.

The visible cross section 14 comprises a plurality of area segments Sⱼ (of which one is shown in FIG. 1), wherein a partial particle flux emerges towards target point Pᵢ from each segment Sⱼ. A vector \vec{r} connects the target point Pᵢ with the area segment Sⱼ. In order to determine the value representing the (total) flux of particles to target point Pᵢ, the contributions of each of the area segments Sⱼ have to be summed. In one example, the area segments Sⱼ are assumed to be infinitesimally small (i.e., an area segment dS is considered) such that the value representing the total flux at point Pᵢ can be calculated by integrating a function representing the flux at area segments Sⱼ over the visible cross section (CS) (view factor integral). This leads to the following general expression for the value (denoted F) representing the flux at point Pᵢ:

$$F = {\int }_{C S} \frac{cos ( {θ}_{j} ) \cdot cos ( {θ}_{i} )}{π \cdot {r}^{2}} d S \\ with \\ cos ( {θ}_{i} ) = \frac{{{n}^{->}}_{i} {r}^{->}}{\vert {r}^{->} \vert} and cos ( {θ}_{j} ) = \frac{{{n}^{->}}_{j} {r}^{->}}{\vert {r}^{->} \vert} \qquad ( 1 )$$

CS: denotes the visible cross section;
\vec{r}: denotes a vector from the sidewall portion to the differential area dS;
\vec{n}ⱼ: denotes the normal vector of the differential area dSⱼ, i.e., \vec{n}ⱼ=(0,0,1);
\vec{n}ᵢ: denotes the normal vector of the sidewall portion in the region of point Pᵢ, i.e., \vec{n}ᵢ=(1,0,0).

The first cosine expression cos(θⱼ) of the integral in equation (1) relates to the flux that emerges from the area segment dS in the direction of \vec{r}. The second cosine expression cos(θᵢ) takes into account that the normal vector of a sidewall portion (which is, e.g., infinitesimally small) surrounding point Pᵢ is tilted with respect to vector \vec{r}.

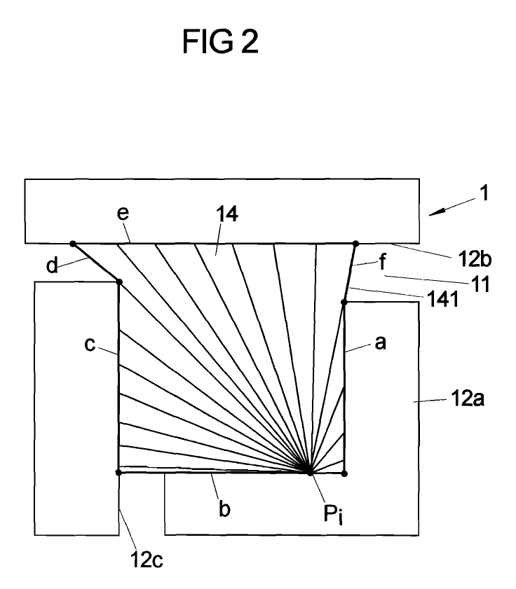

Having determined the value F representing the flux at point Pᵢ, a correction value can be deviated which is used to correct a measure of the mask layout, e.g., the etch bias correction can be deviated from the value F in case the processing step is an etching step. Obviously, value F and the corresponding correction value can be determined for a plurality of target points (portions) in order to be able to deduct a more precise correction in the case of mask structures that lead to a visible cross section with a more complex geometry (see, for example, FIG. 2).

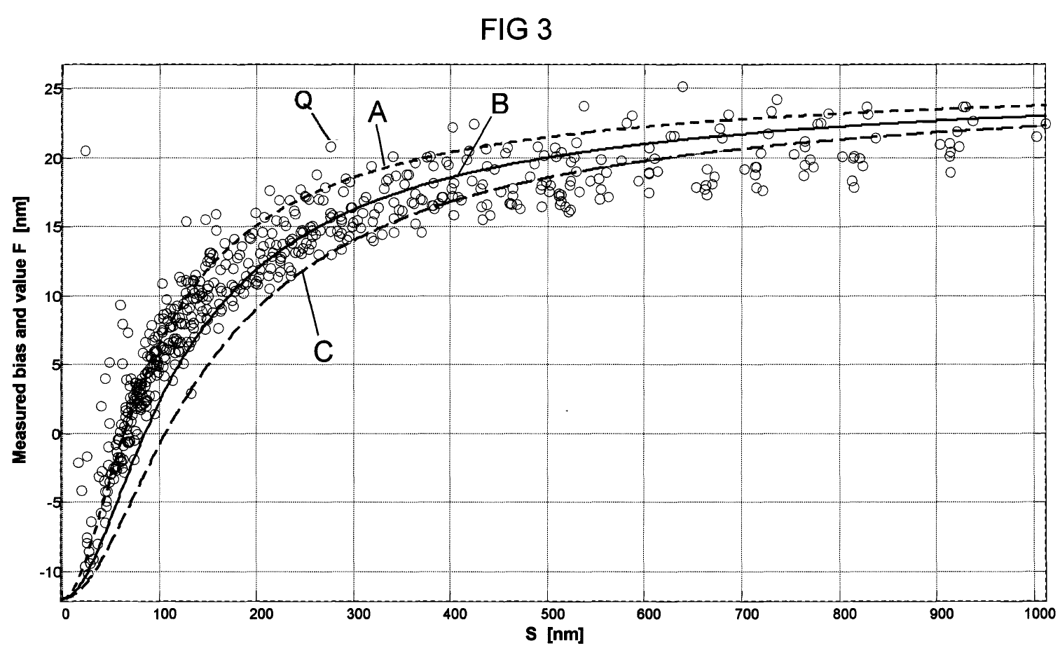

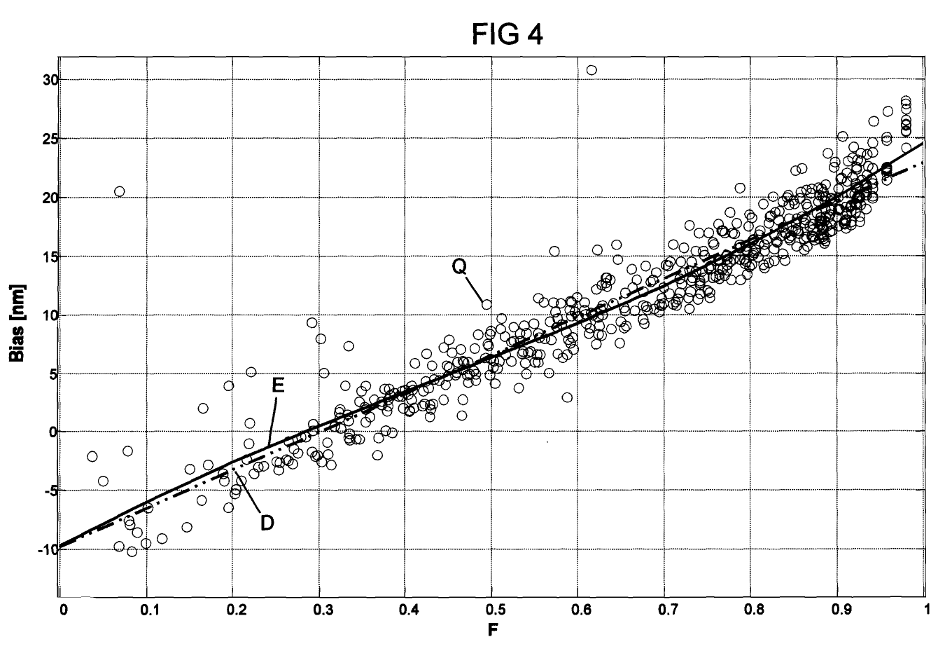

In an example, the correction value is calculated as a polynomial function of value F, the polynomial having an odd degree (e.g., a linear or a cubic function). An example of how an etch bias is determined from the F value (view factor) representing the particle flux is illustrated in FIGS. 3 and 4.

Equation (1) does not take into account that the particles may be reflected by a neighbouring sidewall before hitting point Pᵢ, i.e., it is assumed that the particles have an adhesion coefficient near one. In order to take into account reflections, an integral similar to the integral in equation (1) also has to be evaluated (instead or in addition to the integral in equation (1)), wherein the integration is performed over the area visible from a reflection point and the reflecting area that is visible from the target point.

The integral in equation (1) can be solved numerically using, e.g., a boundary integral method or finite elements. In the case of finite elements (or finite differences) the visible cross section is segmented and the integrand (the “kernel”) of the integral in equation (1) is determined by summing up integrals individually evaluated over the segments.

Also, it can be solved analytically in special cases, e.g., in the case of a mask opening which has the form of a linear trench. This is set forth in the following, wherein a trench with width (spacing) s, length w and height h is contemplated. In this case the first and the second cosine expression in equation (1) yield:

$$cos ( {θ}_{i} ) = \frac{x}{\sqrt{{x}^{2} + {y}^{2} + {h}^{2}}} , cos ( {θ}_{j} ) = \frac{h}{\sqrt{{x}^{2} + {y}^{2} + {h}^{2}}}$$

Therefore equation (1) can be written as:

$$F = {\int }_{x = 0}^{s} {\int }_{y = - w}^{w} \frac{h \cdot x}{π \cdot {( {x}^{2} + {y}^{2} + {h}^{2} )}^{2}} d y \cdot d x \qquad ( 2 )$$

For a visible cross section that is symmetrical in the y direction, the integral in equation (2) can be analytically evaluated, giving:

$$F = \frac{1}{π} [ arctan ( \frac{w}{h} ) - \frac{h}{\sqrt{{s}^{2} + {h}^{2}}} arctan ( \frac{w}{\sqrt{{s}^{2} + {h}^{2}}} ) ] \qquad ( 3 )$$

If a trench with infinite length w is considered, the following expression results from equation (3):

$$F = \frac{1}{2} [ 1 - \frac{h}{\sqrt{{s}^{2} + {h}^{2}}} ] \qquad ( 4 )$$

It is noted that height h might simply be chosen to be the height of the mask opening, e.g., the height of a sidewall of a resist or hard mask before processing is started. In another embodiment, height h is assumed to be an effective height taking into account that the trench height changes during the processing step. An effective height can be determined by fitting equation (4) to measured values (e.g., measured etch bias values). This is explained in more detail in conjunction with FIGS. 3 and 4.

It is further noted that an expression similar to equation (4) can be derived for mask openings with a curved or tilted (non-vertical) sidewall. For this, width s is to be transformed into an effective width and the integral in equation (1) is written in a more general form including more generally \vec{n}ᵢ=(sin θ,0, cos θ) defined normal vectors \vec{n}ⱼ and \vec{n}ᵢ such as for a sidewall with taper angle θ.

In another example the integral in equation (1) is written using polar coordinates (for the definition of rp and φ see FIG. 1), yielding:

$$F = {\int }_{φ = - π / 2}^{π / 2} {\int }_{r p = 0}^{r} \frac{h \cdot r {p}^{2} \cdot cos ( ϕ )}{π \cdot {( r {p}^{2} + {h}^{2} )}^{2}} d r p \cdot d ϕ \qquad ( 5 )$$

In the case of a segment of a circle with radius r₁ and extending between angles φ₁ and φ₂ equation (5) gives:

$$F = \frac{1}{2 π} ( arctan ( \frac{{r}_{1}}{h} ) - \frac{\frac{{r}_{1}}{h}}{1 + {( \frac{{r}_{1}}{h} )}^{2}} ) ( sin ( {φ}_{2} ) - sin ( {φ}_{1} ) ) \qquad ( 6 )$$

If a semicircle is contemplated it results:

$$F = \frac{1}{π} ( arctan ( \frac{{r}_{1}}{h} ) - \frac{\frac{{r}_{1}}{h}}{1 + {( \frac{{r}_{1}}{h} )}^{2}} ) \qquad ( 7 )$$

In another embodiment of the invention, the integral in equation (1) is solved for an arbitrary cross section by approximating its contour by a polygon and writing the integral in contour integral formulation, e.g.:

$$F = \frac{1}{2 π} {∮}_{\partial {A}_{i}} d λ \frac{1}{{r}^{2}} [ \frac{\partial z}{\partial λ} y - \frac{\partial y}{\partial λ} z ] \\ with j = ( 0 , 0 , 0 ) {x}^{->} ( λ ) = ( x ( λ ) , y ( λ ) , z ( λ ) ) {r}^{2} = {x ( λ )}^{2} + {y ( λ )}^{2} + {z ( λ )}^{2} . \qquad ( 8 )$$

If height h is assumed to be constant, the contribution of a line segment n is:

$$\begin{matrix}F ( n ) = \frac{- h}{2 π} {\int }_{0}^{1} d λ \frac{{y}_{n} - {y}_{n - 1}}{( {x ( λ )}^{2} + {y ( λ )}^{2} + {z ( λ )}^{2} )} \\ = \frac{h ( {y}_{n - 1} - {y}_{n} )}{2 π \sqrt{D}} \{ \begin{matrix}Arc Tan [ \frac{{x}_{n}^{2} + {y}_{n}^{2} - {x}_{n - 1} {x}_{n} - {y}_{n - 1} {y}_{n}}{\sqrt{D}} ] ++ \\ Arc Tan [ \frac{{x}_{n - 1}^{2} + {y}_{n - 1}^{2} - {x}_{n - 1} {x}_{n} - {y}_{n - 1} {y}_{n}}{\sqrt{D}} ]\end{matrix} \}\end{matrix} \\ with D = {h}^{2} ( {( {x}_{n - 1} - {x}_{n} )}^{2} + {( {y}_{n - 1} - {y}_{n} )}^{2} ) + {( {x}_{n} {y}_{n - 1} - {x}_{n - 1} {y}_{n} )}^{2} . \qquad ( 9 )$$

If height h is assumed to be variable, the contribution of a line segment n is:

$$\begin{matrix}F ( n ) = \frac{1}{2 π} {\int }_{0}^{1} d λ \frac{\begin{matrix}( {z}_{n} - {z}_{n - 1} ) ( {y}_{n - 1} + λ ( {y}_{n} - {y}_{n - 1} ) ) - \\ ( {y}_{n} - {y}_{n - 1} ) ( {z}_{n - 1} + λ ( {z}_{n} - {z}_{n - 1} ) )\end{matrix}}{{r}_{0}^{2}} \\ = \frac{( {y}_{n - 1} {z}_{n} - {y}_{n} {z}_{n - 1} )}{2 π \sqrt{D}} \{ \begin{matrix}Arc Tan [ \frac{\begin{matrix}{x}_{n}^{2} + {y}_{n}^{2} + {z}_{n}^{2} - {x}_{n - 1} {x}_{n} - \\ {y}_{n - 1} {y}_{n} - {z}_{n - 1} {z}_{n}\end{matrix}}{\sqrt{D}} ] + \\ Arc Tan [ \frac{\begin{matrix}{x}_{n - 1}^{2} + {y}_{n - 1}^{2} + {z}_{n - 1}^{2} - {x}_{n - 1} {x}_{n} - \\ {y}_{n - 1} {y}_{n} - {z}_{n - 1} {z}_{n}\end{matrix}}{\sqrt{D}} ]\end{matrix} \}\end{matrix} \\ With D = ( {{x}_{n}^{2} ( {y}_{n - 1} + {z}_{n - 1} )}^{2} + {{x}_{n - 1}^{2} ( {y}_{n} + {z}_{n} )}^{2} + {( {y}_{n} {z}_{n - 1} - {y}_{n - 1} {z}_{n} )}^{2} - 2 {x}_{n - 1} {x}_{n} ( {y}_{n - 1} {y}_{n} + {z}_{n - 1} {z}_{n} ) ) . \qquad ( 10 )$$

The contour integration formulation thus permits evaluation of the integral in equation (1) as a function of the starting and end points of the different contour segments.

The contour integration method is illustrated in FIG. 2. A masking structure 1 is generated using a mask layout to comprise an opening 11 that is partially delimited by three separate sidewalls 12a, 12b, 12c. In order to determine a corrected mask layout, a method according to one of the embodiments described above is used. For example, a point Pᵢ located on sidewall 12a is considered from which a cross section 14 of opening 11 is visible. The visible cross section 14 is surrounded by a boundary 141 that can be separated into linear segments a-f.

Using the boundary segments a-f the integral in equation (1) is evaluated (e.g., using equation (9) or (10)) to obtain an expression F representing the flux at point Pᵢ. F is then used to determine a correction value to correct a measure of the mask layout (e.g., a horizontal distance between sidewalls 12a and 12c or a vertical distance between sidewalls 12b and 12a).

Equations (7) and (9) can in particular be used for correction of the full layout of an integrated circuit.

FIG. 3 illustrates the relationship between measured etch bias values (y-axis) and the width s of a longitudinal opening (i.e., a trench) of a masking structure (e.g., a resist structure), wherein both the etch bias and the width are given in nanometers. The measured data points are represented by open circles Q.

The measured data is fitted using an equation based on equation (4) mentioned above, more particularly using:

$${F}^{′} = a [ 1 - \frac{h}{\sqrt{{h}^{2} + {s}^{2}}} ] + o \qquad ( 11 )$$

The resulting curves A, B, C are shown in FIG. 3, wherein different values of trench height h are used (A: h=60 nm, B: h=80 nm and C: h=100 nm). The measured values Q are best matched by curve A based on height h=60 nm.

Fitting equation (11) to measured etch bias values thus permits the determination of an effective height h (which is 60 nm in this case). This effective height can then be used to determine another value representing a particle flux to another target point, e.g., on a different structure (opening), from which the visible cross section has a more complex geometry. Thus, an opening providing a visible cross section with a simple geometry such as a trench (resulting in a one-dimensional formulation of equation (1)) can be used to calibrate the method (i.e., to determine an effective height h). In a subsequent step, a more complex visible cross section is evaluated, e.g., by approximating the boundary of the visible cross section by a polygon.

As illustrated in FIG. 4, etch bias correction values (y-axis) are calculated from flux values (view factors) F (x-axis) using a linear (curve D) and a cubic (curve E) polynomial function of F, respectively. The values F are determined using equation (4) with the effective height that has been determined by fitting of the measured data with equation (11). As can be seen in FIG. 4, both curve D and curve E well match the measured values Q.

What is claimed is:

1. A method of performing proximity correction of a mask layout that is used during generation of a masking structure for performing a processing step, the masking structure comprising at least one opening that is delimited by a sidewall and that exposes an area that is to be processed, the method comprising:
determining a value representing a flux of particles to a target portion, wherein the target portion is a portion of the sidewall and/or a portion of the exposed area, and wherein the particles are generated during the processing of the exposed area; and
determining a corrected mask layout depending on the determined value.

2. The method according to claim 1, wherein the processing step comprises an etching step.

3. The method according to claim 1, wherein the determined value is proportional to an absolute value of the flux of particles to the target portion.

4. The method according to claim 1, wherein the value representing the flux of particles to the target portion is determined assuming that the particles emerge from a part of a cross section of the opening that is visible from the target portion.

5. The method according to claim 4, wherein a cross section that is parallel to the exposed area to be processed and that is located in a region of an upper side of the opening is assumed.

6. The method according to claim 1, wherein the value representing the flux of particles is determined assuming that the particles arrive at the target portion without being reflected.

7. The method according to claim 1, wherein the value representing the flux of particles is determined assuming that the particles are reflected before arriving at the target portion.

8. The method according to claim 1, wherein the target portion is a point located on the sidewall and in the plane of the exposed area to be processed.

9. The method according to claim 4, wherein the value representing the flux of particles is determined by summarizing a plurality of values representing different partial flux to the target portion emerging from different portions of the visible cross section.

10. The method according to claim 9, wherein the value is determined by calculating an integral of a function representing a flux emerging from differential areas of the visible cross section, the integral being evaluated over the visible cross section.

11. The method according to claim 10, wherein the value representing the flux of particles to the target portion is denoted F and is calculated according to
$$F = {\int }_{C S} \frac{cos ( {θ}_{j} ) \cdot cos ( {θ}_{i} )}{π \cdot {r}^{2}} d {S}_{j}$$
$$with$$
$$cos ( {θ}_{i} ) = \frac{{{n}^{->}}_{i} {r}^{->}}{\vert {r}^{->} \vert} and cos ( {θ}_{j} ) = \frac{{{n}^{->}}_{j} {r}^{->}}{\vert {r}^{->} \vert}$$
wherein
CS denotes the visible cross section;
\vec{r} denotes a vector from a sidewall portion to a differential area dS;
\vec{n}ⱼ denotes a normal vector of the differential area dS; and
\vec{n}ᵢ denotes a normal vector of the sidewall portion.

12. The method according to claim 11, wherein the integral is calculated using a contour integral method, wherein a contour of the cross section is represented by a polygon.

13. The method according to claim 12, wherein the opening comprises a trench with width s, length w and height h and the value F is calculated from
$$F = {\int }_{x = 0}^{s} {\int }_{y = - w}^{w} \frac{h \cdot x}{π \cdot {( {x}^{2} + {y}^{2} + {h}^{2} )}^{2}} d y \cdot d x$$

14. The method according to claim 13, wherein the length w is assumed to be infinite and the value F is calculated from
$$F = \frac{1}{2} [ 1 - \frac{h}{\sqrt{{h}^{2} + {s}^{2}}} ]$$

15. The method according to claim 14, wherein
a plurality of correction values for a plurality of openings with different widths is measured;
the measured correction values are fitted with an expression based on the equation of claim 14 related to a first target portion in order to determine a value of height h; and
a value representing a flux to a second target portion is determined using the determined value of height h.

16. The method according to claim 1, wherein a correction value is calculated dependent on the determined value, the correction value being used to correct a measure of the mask layout.

17. The method according to claim 16, wherein the correction value is calculated as a polynomial function of the determined value.

18. The method according to claim 1, wherein the sidewall comprises a curved or tilted sidewall.

19. The method according to claim 1, wherein the method steps are represented by a programming code that can be executed on a computer.

20. A storage medium comprising programming code that represents the method steps of claim 1.

21. A programmable device programmed to perform the method according to claim 1.
